(19) United States
(12) Patent Application Publication
(10) Pub. No.: US 2023/0216041 A1
(43) Pub. Date: Jul. 6, 2023

(54) SILICON ANODE FOR USE IN AN ELECTROCHEMICAL CELL

(71) Applicant: Solid Power Operating, Inc., Louisville, CO (US)

(72) Inventors: Collin R. BECKER, Boulder, CO (US); Rose E. RUTHER, Lafayette, CO (US); Kristen T. HIETALA, Boulder, CO (US)

(21) Appl. No.: 18/092,166

(22) Filed: Dec. 30, 2022

Related U.S. Application Data
(60) Provisional application No. 63/295,291, filed on Dec. 30, 2021.

(51) Int. Cl. H01M 4/38; H01M 4/62; H01M 10/0525

(52) U.S. Cl. CPC H01M 4/386; H01M 4/625; H01M 4/621; H01M 10/0525; H01M 2004/027

(57) ABSTRACT

Described herein are composite anode compositions comprising silicon for use in an electrochemical cell. The composite anode compositions described herein include silicon as an anode active material having a particle size, crystallite size, and surface area that provide desired electrochemical properties. Further provided herein are electrochemical cells comprising the anode compositions and methods of making the same.

### CROSS-REFERENCE TO RELATED APPLICATIONS

This application claims priority to U.S. Provisional Application No. 63/295,291 entitled “SILICON ANODE FOR SOLID STATE BATTERY”, filed Dec. 30, 2021, the entire contents of which are incorporated herein by reference.

### TECHNICAL FIELD

Various embodiments described herein relate to the field of solid-state primary and secondary electrochemical cells, electrodes, and electrode materials, and the corresponding methods of making and using the same.

### BACKGROUND

Lithium-based rechargeable batteries are popular to power many forms of modern electronics and have the capability to serve as the power source for hybrid and fully electric vehicles. State-of-the-art lithium-based rechargeable batteries typically employ a carbon-based anode to store lithium ions. In these anodes, lithium ions are stored by intercalating between planes of carbon atoms that compose graphite particles. Carbon-based anodes have been tailored to confer acceptable performance in modern lithium-ion batteries. However, carbon-based anodes are reaching maturity in terms of their lithium-ion storage.

An alternative to the carbon-based anode is an alloy-type anode. In the alloy-type anode, rather than intercalating between sheets of carbon in graphite particles, the lithium ions alloy with the active anode material. These materials may have up to ten times (10×) more lithium-ion storage capacity as compared to that of graphite anodes. The typical alloy-type anodes include silicon, tin, and aluminum, as well as more exotic materials, such as germanium and gold. These alloy materials have their own advantages and disadvantages, such as cost, specific capacity, processability, and voltage penalty.

One of the challenges to confront in these systems is the volume change associated with alloying lithium with the active material. For example, volume changes near 400% can happen with some systems. The volume change can cause difficulties from a macro and micro level. At the macro level, a battery pack may have to accommodate a swelling cell, and at the micro level, the continuous expansion and contraction of the active area can lead to cracking. The particles in the active area then can lose electrical connection with their surrounding matrix and can also undergo undesirable side reactions between the fresh surfaces of the particles and the battery electrolyte.

Silicon (Si) is one example of an alloy-type anode material, which theoretically can store more than ten times the amount of lithium ions as compared to graphite, has a modest voltage penalty, and in its bulk form is abundant and inexpensive. Unfortunately, in conventional liquid electrolyte lithium-ion cells, the large (e.g., 400%) volume change of silicon-lithium alloys has frustrated efforts to employ silicon in the anode. As the material expands and contracts, cracking occurs and the fresh surfaces of the cracks that are exposed react to form a new solid electrolyte interphase, which consumes electrolyte and the supply of lithium in the cell. Therefore, the cell loses a portion of its capacity during each cycle and may ultimately fail after some numbers of cycles.

Although progress has been made in the field of lithium batteries, there remains a need in the art for a solid-state anode that is more resistive to cracking and that has improved coulombic efficiency.

### SUMMARY

Provided herein are composite anodes for electrochemical cells. The composite anode compositions generally comprise silicon or an alloy thereof in an amount of at least about 30 wt % of the composite anode, a solid electrolyte material in an amount from about 0 wt % to about 40 wt % of the composite anode, and a binder in an amount from about 0 wt % to about 20 wt % of the composite anode.

In some embodiments, the silicon has a particle size from about 10 nm to about 300 nm. In an exemplary embodiment, the silicon has an average particle size from about 50 nm to about 80 nm.

In some embodiments, the silicon has a crystallite size from about 1 nm to about 50 nm. In an exemplary embodiment, the silicon has a crystallite size from about 1 nm to about 20 nm.

In some embodiments, the silicon has a surface area from about 1 m²/g to about 50 m²/g, or from about 1 m²/g to about 20 m²/g. In some additional embodiments, the silicon has a surface area of less than about 20 m²/g.

In some embodiments, the silicon has a ratio of crystallite size to surface area (nm:m²/g) from about 1:50 to about 50:1. In some embodiments, the silicon has a ratio of crystallite size to particle size (nm:nm) from about 1:300 to about 1:1. In still further embodiments, the silicon has a ratio of surface area to particle size (m²/g:nm) from about 1:300 to about 50:10.

In some embodiments, the silicon is present in an amount from about 30 wt % to about 98 wt % of the composite anode. In some additional embodiments the silicon is present in an amount of at least about 40 wt % of the composite anode.

In some embodiments, the composite anode further comprises a conductive additive in an amount of about 0 wt % to about 15 wt % of the composite anode. In some embodiments, the conductive additive comprises one or more of carbon fiber, graphite, graphene, carbon black, conductive carbon, amorphous carbon, VGCF, silicon-carbon composites, and carbon nanotubes. In some additional embodiments, the conductive additive has a particle size from about 5 nm to about 100 nm.

In some embodiments, the composite anode has a density from about 1 g/cm³ to about 1.75 g/cm³.

In some embodiments, the composite anode further comprises an anode active material including tin, germanium, graphite, Li₄Ti₅O₁₂, hard carbons, or combinations thereof.

Further provided herein is a composite anode composition comprising silicon or an alloy thereof in an amount of at least about 30 wt % of the composite anode, a solid electrolyte material in an amount from about 0 wt % to about 40 wt % of the composite anode, and a binder in an amount from about 0 wt % to about 20 wt % of the composite anode, wherein the silicon has one or more of the following properties: a particle size from about 10 nm to about 100 nm, a crystallite size from about 1 nm to about 20 nm, and a surface area from about 1 m²/g to about 20 m²/g.

In some embodiments, the silicon has a ratio of crystallite size to surface area (nm:m²/g) from about 1:50 to about 50:1. In some embodiments, the silicon has a ratio of crystallite size to particle size (nm:nm) from about 1:300 to about 1:1. In still further embodiments, the silicon has a ratio of surface area to particle size (m²/g:nm) from about 1:300 to about 50:10.

Further provided herein is a composite anode composition comprising silicon or an alloy thereof in an amount of at least about 30 wt % of the composite anode, a solid electrolyte material in an amount from about 0 wt % to about 40 wt % of the composite anode, and a binder in an amount from about 0 wt % to about 20 wt % of the composite anode, wherein the silicon has two or more of the following properties: a particle size from about 10 nm to about 100 nm, a crystallite size from about 1 nm to about 20 nm, and a surface area from about 1 m²/g to about 20 m²/g.

In some embodiments, the silicon has a ratio of crystallite size to surface area (nm:m²/g) from about 1:50 to about 50:1. In some embodiments, the silicon has a ratio of crystallite size to particle size (nm:nm) from about 1:300 to about 1:1. In still further embodiments, the silicon has a ratio of surface area to particle size (m²/g:nm) from about 1:300 to about 50:10.

Further provided herein is a composite anode composition comprising silicon or an alloy thereof in an amount of at least about 30 wt % of the composite anode, a solid electrolyte material in an amount from about 0 wt % to about 40 wt % of the composite anode, and a binder in an amount from about 0 wt % to about 20 wt % of the composite anode, wherein the silicon has the following properties: a particle size from about 10 nm to about 100 nm, a crystallite size from about 1 nm to about 20 nm, and a surface area from about 1 m²/g to about 20 m²/g.

In some embodiments, the silicon has a ratio of crystallite size to surface area (nm:m²/g) from about 1:50 to about 50:1. In some embodiments, the silicon has a ratio of crystallite size to particle size (nm:nm) from about 1:300 to about 1:1. In still further embodiments, the silicon has a ratio of surface area to particle size (m²/g:nm) from about 1:300 to about 50:10.

Further provided herein are electrochemical cells. The electrochemical cells generally comprise a composite anode, a cathode, and an electrolyte layer. The composite anode includes silicon or an alloy thereof in an amount of at least about 30 wt % of the composite anode, a solid electrolyte material in an amount from about 0 wt % to about 40 wt % of the composite anode, and a binder in an amount from about 0 wt % to about 20 wt % of the composite anode.

In some embodiments, the silicon has a particle size from about 10 nm to about 100 nm. In an exemplary embodiment, the silicon has an average particle size from about 50 nm to about 80 nm.

In some embodiments, the silicon has a crystallite size from about 1 nm to about 50 nm. In an exemplary embodiment, the silicon has a crystallite size from about 1 nm to about 20 nm.

In some embodiments, the silicon has a surface area from about 1 m²/g to about 50 m²/g, or from about 1 m²/g to about 20 m²/g. In some additional embodiments, the silicon has a surface area of less than about 20 m²/g.

In some embodiments, the silicon is present in an amount from about 30 wt % to about 98 wt % of the composite anode. In some additional embodiments the silicon is present in an amount of at least about 40 wt % of the composite anode.

In some embodiments, the silicon has a ratio of crystallite size to surface area (nm:m²/g) from about 1:50 to about 50:1. In some embodiments, the silicon has a ratio of crystallite size to particle size (nm:nm) from about 1:300 to about 1:1. In still further embodiments, the silicon has a ratio of surface area to particle size (m²/g:nm) from about 1:300 to about 50:10.

In some embodiments, the composite anode further comprises a conductive additive in an amount of about 0 wt % to about 15 wt % of the composite anode. In some embodiments, the conductive additive comprises one or more of carbon fiber, graphite, graphene, carbon black, conductive carbon, amorphous carbon, VGCF, silicon-carbon composites, and carbon nanotubes. In some additional embodiments, the conductive additive has a particle size from about 5 nm to about 100 nm.

In some embodiments, the composite anode has a density from about 1 g/cm³ to about 1.75 g/cm³.

In some embodiments, the composite anode further comprises an anode active material including tin, germanium, graphite, Li₄Ti₅O₁₂, hard carbons, or combinations thereof.

In some embodiments, the cathode comprises a cathode active material. In some embodiments, the cathode comprises a conductive additive. In some embodiments, the cathode comprises a solid-state electrolyte.

In some embodiments, the electrolyte layer comprises a solid-state electrolyte. In some additional embodiments, the electrolyte layer comprises a binder. In some embodiments, the electrolyte layer is disposed between the composite anode and the cathode.

In some embodiments, the electrochemical cell further comprises a first current collector and a second current collector. In some aspects, the first current collector is disposed adjacent to the composite anode. In some additional aspects, the second current collector is disposed adjacent to the cathode.

Further provided herein is a method of preparing a composite anode for an electrochemical cell. The method comprises combining silicon or an alloy thereof, a solid electrolyte material, and a binder to form a composite mixture, adding a solvent to the composite mixture to form a slurry, casting the slurry onto a substrate, and drying the slurry on the substrate to form the composite anode. In some embodiments, the method further comprises densifying the composite anode.

In some embodiments, the silicon has a particle size from about 10 nm to about 100 nm. In an exemplary embodiment, the silicon has an average particle size from about 50 nm to about 80 nm.

In some embodiments, the silicon has a crystallite size from about 1 nm to about 50 nm. In an exemplary embodiment, the silicon has a crystallite size from about 1 nm to about 20 nm.

In some embodiments, the silicon has a surface area from about 1 m²/g to about 50 m²/g, or from about 1 m²/g to about 20 m²/g. In some additional embodiments, the silicon has a surface area of less than about 20 m²/g.

In some embodiments, the silicon is present in an amount from about 30 wt % to about 98 wt % of the composite anode. In some additional embodiments the silicon is present in an amount of at least about 40 wt % of the composite anode.

In some embodiments, the silicon has a ratio of crystallite size to surface area (nm:m²/g) from about 1:50 to about 50:1. In some embodiments, the silicon has a ratio of crystallite size to particle size (nm:nm) from about 1:300 to about 1:1. In still further embodiments, the silicon has a ratio of surface area to particle size (m²/g:nm) from about 1:300 to about 50:10.

In some embodiments, the composite mixture further comprises a conductive additive in an amount of about 0 wt % to about 15 wt % of the composite anode. In some embodiments, the conductive additive comprises one or more of carbon fiber, graphite, graphene, carbon black, conductive carbon, amorphous carbon, VGCF, silicon-carbon composites, and carbon nanotubes. In some additional embodiments, the conductive additive has a particle size from about 5 nm to about 100 nm.

In some embodiments, the composite anode has a density from about 1 g/cm³ to about 1.75 g/cm³.

In some embodiments, the composite mixture further comprises an anode active material including tin, germanium, graphite, Li₄Ti₅O₁₂, hard carbons, or combinations thereof.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 shows plots comparing the cycle life of the electrochemical cells made in Example 1, Comparative Example 1, and Comparative Example 2.

FIG. 2 shows a plot comparing the cycle life of the electrochemical cells made in Example 1, Example 2, and Comparative Example 3.

FIG. 3 shows a plot comparing the cycle life of the electrochemical cells made in Example 1 and Comparative Example 4.

### DETAILED DESCRIPTION

In the following description, specific details are provided to impart a thorough understanding of the various embodiments of the disclosure. Upon having read and understood the specification, claims, and drawings hereof, those skilled in the art will understand that some embodiments may be practiced without hewing to some of the specific details set forth herein. Moreover, to avoid obscuring the disclosure, some well-known methods, processes, devices, and systems utilized in the various embodiments described herein are not disclosed in detail.

The inventors surprisingly found that nanostructured silicon composed of branched particles with low surface area demonstrates very high first cycle efficiency when integrated into a solid-state electrolyte. As used herein, “branched particles” refers to particles that include three or more primary particles in a series. As used herein, a “primary particle” refers to an individual grain in a powder material. Each primary particle may comprise one or more crystallites. Crystallites, as used herein, refer to individual crystals which form the primary particles. Two or more primary particles may agglomerate to form secondary particles. Due to the low surface area, there is only a small amount of silicon that requires passivation through side reactions. Additionally, the branched structure creates a porous architecture, which makes it difficult for the solid-state electrolyte material to directly contact the silicon. Since the solid-state electrolyte is not mobile, silicon surfaces that are not in contact with the electrolyte initially will never undergo a reaction with the electrolyte.

The porous, branched, rough network of the nanostructured silicon is also able to anchor itself into the surrounding composite matrix to create a mechanically robust structure as measured by anode cohesion. Without wishing to be bound by theory, silicon powders with higher surface area tend to have poorer anode cohesion and may require more binder to maintain structural integrity. With a strong interface formed, lithium transport to the silicon particles is facile and particles remain anchored in the network. Furthermore, the voids in the branched network allow room for the silicon to expand, which explains the high capacity of this particular silicon morphology. With this silicon structure in a solid-state electrolyte, there are a limited amount of side reactions that can occur, voids exist to accommodate silicon expansion, and the particles remain solidly anchored in the composite matrix. The net effect is a very high first cycle efficiency giving rise to high capacity and long cycle life.

The nanoscale silicon also has a low surface area. The low surface area and small particle size lead to the formation of an agglomerated or chain-like morphology that structurally supports the silicon anode.

The nanoscale silicon further has a low crystallite size. As previously mentioned, crystallites are individual crystals that form the primary particles of silicon. The small crystallite size and low surface area silicon results in an electrochemical cell with increased cell performance compared to cells that use silicon with small crystallite size and high surface area and silicon with large crystallite size and low surface area. The small crystallite size of the silicon used herein alleviates cracking of individual particles and potential loss of active material. The specific morphology of small crystallite size and low surface area prevents the silicon from forming a detrimental Li₁₅Si₄ phase, which tends to form when the silicon is fully lithiated. Additionally, using the small crystallite size and low surface area Si material allows for the increase in processability by allowing for mixing the composite into a slurry with rheological properties ideal for casting/coating. These properties include high solids loading which allows for using less solvent, cutting back on the dry time of the casted layers and slurry stability, thereby giving a larger window of time to perform casting and/or coating.

Preferably, the composite anodes of the present disclosure comprise less than 10 wt % Li₁₅Si₄ after lithiation in an electrochemical cell. For example, the composite anodes of the present disclosure may comprise less than 10 wt % Li₁₅Si₄, less than 9 wt % Li₁₅Si₄, less than 8 wt % Li₁₅Si₄, less than 7 wt %, Li₁₅Si₄, less than 6 wt % Li₁₅Si₄, less than 5 wt % Li₁₅Si₄, less than 4 wt % Li₁₅Si₄, less than 3 wt % Li₁₅Si₄, less than 2 wt % Li₁₅Si₄, or less than 1 wt % Li₁₅Si₄ after lithiation in an electrochemical cell.

A high first cycle efficiency is beneficial to enabling a long-life lithium-ion cell. In a cell with a lithium containing cathode and an anode initially devoid of lithium, the cyclable lithium available to the cell is contained in the cathode. During the first charge of the cell, lithium is removed from the cathode and reacts with the active component of the anode. Some of the lithium may be lost to undesirable side reactions in this process. Additionally, upon discharge, some lithium can be trapped in active components that are ionically or electrically isolated due to cracking or separation caused by volume change. This lithium loss decreases the capacity of the cell and reduces the cycle life.

In some embodiments, the composite anode may have a thickness from about 1 μm to about 100 μm. In some aspects, the composite anode may have a thickness from about 1 μm to about 10 μm, about 1 μm to about 20 μm, about 1 μm to about 30 μm, about 1 μm to about 40 μm, about 1 μm to about 50 μm, about 1 μm to about 60 μm, about 1 μm to about 70 μm, about 1 μm to about 80 μm, about 1 μm to about 90 μm, about 10 μm to about 100 μm, about 20 μm to about 100 μm, about 30 μm to about 100 μm, about 40 μm to about 100 μm, about 50 μm to about 100 μm, about 60 μm to about 100 μm, about 70 μm to about 100 μm, about 80 μm to about 100 μm, about 90 μm to about 100 μm, about 10 μm to about 50 μm, about 20 μm to about 40 μm, or about 20 μm to about 30 μm. In some additional aspects, the anode may have a thickness of about 1 μm, 5 μm, 10 μm, 20 μm, 30 μm, 40 μm, 50 μm, 60 μm, 70 μm, 80 μm, 90 μm, or about 100 μm. In an exemplary embodiment, the composite anode has a thickness from about 20 μm to about 30 μm.

The anode active material includes silicon having an average particle size of less than about 1000 nm. As used herein, “silicon” refers to silicon metal or an alloy thereof. In spite the difficulties of describing the particle size of silicon as described above, the average particle size (i.e., D₅₀) of the silicon may be described. As used herein, “particle size” refers to the diameter of the primary particles of silicon. In some aspects, the silicon may have an average particle size of less than 500 nm, less than 450 nm, less than 400 nm, less than 350 nm, less than 300 nm, less than 250 nm, less than 200 nm, less than 150 nm, or less than 100 nm. In some examples, the silicon has an average particle size of about 100 nm. The silicon may have a particle size from about 1 nm to about 25 nm, about 1 nm to about 50 nm, about 1 nm to about 75 nm, about 1 nm to about 100 nm, about 1 nm to about 125 nm, about 1 nm to about 150 nm, about 25 nm to about 150 nm, about 50 nm to about 150 nm, about 75 nm to about 150 nm, about 100 nm to about 150 nm, or about 125 nm to about 150 nm. In an exemplary embodiment, the silicon has an average particle size of about 50 nm to about 80 nm.

The silicon may have a surface area from about 1 m²/g to about 100 m²/g. In some aspects, the silicon may have a surface area from about 1 m²/g to about 10 m²/g, about 1 m²/g to about 20 m²/g, about 1 m²/g to about 30 m²/g, about 1 m²/g to about 40 m²/g, about 10 m²/g to about 50 m²/g, about 10 m²/g to about 60 m²/g, about 10 m²/g to about 70 m²/g, about 10 m²/g to about 80 m²/g, about 10 m²/g to about 90 m²/g, about 10 m²/g to about 100 m²/g, about 20 m²/g to about 100 m²/g, about 30 m²/g to about 100 m²/g, about 40 m²/g to about 100 m²/g, about 50 m²/g to about 100 m²/g, about 60 m²/g to about 100 m²/g, about 70 m²/g to about 100 m²/g, about 80 m²/g to about 100 m²/g, about 90 m²/g to about 100 m²/g, about 10 m²/g to about 40 m²/g, or about 20 m²/g to about 40 m²/g. In some examples, the silicon has a surface area of about 30 m²/g. In some additional examples, the silicon has a surface area of less than about 20 m²/g.

The silicon may have a crystallite size from about 1 nm to about 50 nm. The crystallite size may be determined by applying the Scherrer equation or a Rietveld refinement to XRD patterns, as known to those having ordinary skill in the art. In some embodiments, the silicon may have a crystallite size from about 1 nm to about 5 nm, about 1 nm to about 10 nm, about 1 nm to about 20 nm, about 1 nm to about 30 nm, about 1 nm to about 40 nm, about 1 nm to about 50 nm, about 5 nm to about 50 nm, about 10 nm to about 50 nm, about 20 nm to about 50 nm, about 30 nm to about 50 nm, about 40 nm to about 50 nm, about 10 nm to about 40 nm, about 10 nm to about 30 nm, about 10 nm to about 20 nm, about 20 nm, to about 40 nm, or about 30 nm to about 40 nm. In some examples, the silicon may have a crystallite size of about 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, 35 nm, 36 nm, 37 nm, 38 nm, 39 nm, 40 nm, 41 nm, 42 nm, 43 nm, 44 nm, 45 nm, 46 nm, 47 nm, 48 nm, 49 nm, or about 50 nm.

The silicon in the composite anode may have a ratio of crystallite size to surface area (nm:m²/g) from about 1:50 to about 50:1. For example, the ratio of crystallite size to surface area may be from about 1:50 to about 1:25, about 1:50 to about 1:10, about 1:50 to about 1:5, about 1:50 to about 1:2, about 1:50 to about 1:1, about 1:50 to about 2:1, about 1:50 to about 5:1, about 1:50 to about 10:1, about 1:50 to about 25:1, about 1:50 to about 50:1, about 1:25 to about 50:1, about 1:10 to about 50:1, about 1:5 to about 50:1, about 1:2 to about 50:1, about 1:1 to about 50:1, about 2:1 to about 50:1, about 5:1 to about 50:1, about 10:1 to about 50:1, or about 25:1 to about 50:1. The ratio of crystallite size to surface area may be about 1:50, 1:40, 1:30, 1:20, 1:10, 1:5, 1:2, 1:1, 2:1, 5:1, 10:1, 20:1, 30:1, 40:1, or about 50:1. In an exemplary embodiment, the ratio of crystallite size to surface area may be about 1:1. In another exemplary embodiment, the ratio of crystallite size to surface area may be about 1:2.

The silicon in the composite anode may have a ratio of crystallite size to particle size (nm:nm) from about 1:300 to about 1:1. For example, the ratio of crystallite size to particle size may be from about 1:300 to about 1:200, about 1:300 to about 1:100, about 1:300 to about 1:50, about 1:300 to about 1:20, about 1:300 to about 1:10, about 1:300 to about 1:5, about 1:300 to about 1:2, about 1:300 to about 1:1, about 1:300 to about 2:1, about 1:300 to about 5:1, about 1:300 to about 10:1, about 1:300 to about 20:1, about 1:300 to about 50:1, about 1:200 to about 50:1, about 1:100 to about 50:1, about 1:50 to about 50:1, about 1:20 to about 50:1, about 1:10 to about 50:1, about 1:5 to about 50:1, about 1:2 to about 50:1, about 1:1 to about 50:1, about 2:1 to about 50:1, about 5:1 to about 50:1, about 10:1 to about 50:1, or about 20:1 to about 50:1. The ratio of crystallite size to particle size may be about 1:300, 1:250, 1:200, 1:150, 1:100, 1:90, 1:80, 1:70, 1:60, 1:50, 1:40, 1:30, 1:20, 1:10, 1:5, 1:2, or about 1:1. In an exemplary embodiment, the ratio of crystallite size to particle size is about 1:18. In another exemplary embodiment, the ratio of crystallite size to particle size is about 13:50 (i.e., about 1:3.85).

The silicon in the composite anode may have a ratio of surface area to particle size (m²/g:nm) from about 1:300 to about 50:10. For example, the ratio of surface area to particle size may be from about 1:300 to about 1:200, about 1:300 to about 1:100, about 1:300 to about 1:50, about 1:300 to about 1:20, about 1:300 to about 1:10, about 1:300 to about 1:5, about 1:300 to about 1:2, about 1:300 to about 1:1, about 1:300 to about 10:10, about 1:300 to about 20:10, about 1:300 to about 30:10, about 1:300 to about 40:10, about 1:300 to about 50:10, about 1:200 to about 50:10, about 1:100 to about 50:10, about 1:50 to about 50:10, about 1:20 to about 50:10, about 1:10 to about 50:10, about 1:5 to about 50:10, about 1:2 to about 50:10, about 1:1 to about 50:10, about 10:110 to about 50:10, about 20:10 to about 50:10, about 30:10 to about 50:10, or about 40:10 to about 50:1. The ratio of surface area to particle size may be about 1:300, 1:250, 1:200, 1:150, 1:100, 1:90, 1:80, 1:70, 1:60, 1:50, 1:40, 1:30, 1:20, 1:10, 1:5, 1:2, 1:1, 10:10, 20:10, 30:10, 40:10, or about 50:10. In an exemplary embodiment, the ratio of surface area to particle size is about 1:5. In another exemplary embodiment, the ratio of surface area to particle size is about 1:18.

The anode active material may be present in the composite anode in an amount from about 30% to about 98% by weight of the composite anode. In some aspects, the anode active material may be present in the composite anode in an amount from about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 98%, about 40% to about 98%, about 45% to about 98%, about 50% to about 98%, about 55% to about 98%, about 60% to about 98%, about 65% to about 98%, about 70% to about 98%, about 75% to about 98%, about 80% to about 98%, about 85% to about 98%, about 90% to about 98%, about 40% to about 90%, about 40% to about 80%, about 40% to about 70%, about 40% to about 60%, about 40% to about 55%, about 40% to about 50%, or about 40% to about 45% by weight of the composite anode.

In other embodiments, the anode active material may be present in the composite anode in an amount of greater than or equal to about 40% by weight. In some aspects, the anode active material may be present in the composite anode in an amount of about 40% to about 80% by weight, about 40% to about 75% by weight, about 40% to about 70% by weight, about 40% to about 65% by weight, or about 40% to about 60% by weight. In some examples, the anode active material is present in the composite anode in an amount of about 50% to about 60% by weight.

The anode active material may comprise a layer of oxide that forms on the outside of the anode active material. This oxide layer typically forms when the anode active material is in contact with the air. The oxide layer may have a thickness from about 3 nm to about 5 nm. The oxide layer may passivate the surface from further reaction with the air.

Currently, operation of electrochemical cells including solid-state batteries involves applying stack pressure to the battery as it charges and discharges. Stack pressure, sometimes also referred to as a force, involves application of a pressure to the cell to maintain contact between the respective electrodes and the solid electrolyte. A first cell cycle includes a depth of discharge (DoD) of 100%, meaning that the cell is fully charged and then fully discharged. A conditioning cycle includes a DoD of less than 100%, such as less than 90%, less than 80%, less than 70%, less than 60%, less than 50%, less than 40%, less than 30%, less than 20%, or less than 10%. There may be two or more conditioning cycles in a series of conditioning cycles. The DoD in each of the series of conditioning cycles may be equal or may be different between each of the conditioning cycles. The first cycle or the series of conditioning cycles may be part of a formation process prior to use of the battery to power a device. The voltage of each of the series of conditioning cycles may be constant or, in some embodiments, the voltage may be increased for each of the conditioning cycles.

The stack pressure applied during the first cell cycle or the series of conditioning cycles may be between about 100 psi to about 2500 psi. In some aspects, the stack pressure applied during the first cell cycle or the series of conditioning cycles may be about 100 psi to about 500 psi, about 500 psi to about 1000 psi, about 1000 psi to about 1500 psi, about 1500 psi to about 2000 psi, about 2000 psi to about 2500 psi, about 100 psi to about 1000 psi, about 100 psi to about 1500 psi, about 100 psi to about 2000 psi, about 500 psi to about 2500 psi, about 1000 psi to about 2500 psi, about 1500 psi to about 2500 psi, about 500 psi to about 2000 psi, or about 1000 psi to about 2000 psi. In some embodiments, the stack pressure applied during the first cell cycle or the series of conditioning cycles may be greater than 2500 psi. In an exemplary embodiment, the stack pressure applied during the first cell cycle or the series of conditioning cycles is about 1500 psi. In another exemplary embodiment, the stack pressure applied during the first cell cycle or the series of conditioning cycles is about 300 psi.

The stack pressure may be lower than about 300 psi. In some embodiments, the stack pressure may be lower than about 300 psi, lower than about 250 psi, lower than about 200 psi, lower than bout 150 psi, lower than about 100 psi, lower than about 50 psi, lower than about 25 psi, or lower than about 10 psi.

In some embodiments, the stack pressure may remain constant throughout the life of the electrochemical cell. In other embodiments, the stack pressure may be reduced or increased after one or more cell cycles. In an exemplary embodiment, the stack pressure may remain constant throughout the life of the electrochemical cell at 1500 psi. In another exemplary embodiment, the stack pressure may be about 1500 psi during the first cell cycle, and then the stack pressure is reduced to 300 psi for the remaining life of the electrochemical cell.

In one embodiment, the anode active material may further comprise one or more materials such as Tin (Sn), Germanium (Ge), graphite, hard carbons (e.g., amorphous carbon), Li₄Ti₅O₁₂ (LTO), other known anode active materials, and combinations thereof.

In some embodiments, the composite anode may optionally further comprise one or more conductive additives. The conductive additive helps to evenly distribute the charge density throughout the anode. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, VGCF, silicon-carbon composites, and carbon nanotubes.

In some embodiments, the conductive additive may be present in the composite anode in an amount from about 0% to about 15% by weight of the composite anode. In some aspects, the conductive additive may be present in the composite anode in an amount from about 0% to about 10%, or about 0% to about 5% by weight of the composite anode. In some additional aspects, the conductive additive may be present in the composite anode in an amount of about 0%, 1%, 2%, 3%, 4%, 5%, 6%, 7%, 8%, 9%, 10%, 11%, 12%, 13%, 14%, or about 15% by weight of the composite anode. In an exemplary embodiment, the conductive additive is present in the composite anode in an amount from about 0% to about 5% by weight of the composite anode. In other embodiments, the conductive additive may be present in the composite anode in an amount from about 0% to about 20% by weight, about 0% to about 30% by weight, about 0% to about 40% by weight, about 0% to about 50% by weight, or about 0% to about 60% by weight.

In some embodiments, the average particle size of the conductive additive may be from about 5 nm to about 100 nm. In some aspects, the average particle size of the conductive additive may be from about 5 nm to about 10 nm, about 5 nm to about 20 nm, about 5 nm to about 30 nm, about 5 nm to about 40 nm, about 5 nm to about 50 nm, about 5 nm to about 60 nm, about 5 nm to about 70 nm, about 5 nm to about 80 nm, about 5 nm to about 90 nm, about 10 nm to about 100 nm, about 20 nm to about 100 nm, about 30 nm to about 100 nm, about 40 nm to about 100 nm, about 50 nm to about 100 nm, about 60 nm to about 100 nm, about 70 nm to about 100 nm, about 80 nm to about 100 nm, about 90 nm to about 100 nm, about 10 nm to about 50 nm, or about 20 nm to about 40 nm. In some examples, the conductive additive may have a particle size of about 30 nm.

In some embodiments, the composite anode may further optionally comprise one or more solid-state electrolyte materials. The solid-state electrolyte material, along with the conductive additive, helps to evenly distribute the charge density throughout the anode. The one or more solid-state electrolyte material may comprise an oxide, oxysulfide, sulfide, halide, nitride, or any other solid-state electrolyte known in the art. In some preferred embodiments, the one or more solid-state electrolyte materials may comprise a sulfide solid-state electrolyte material, i.e., a solid-state electrolyte having at least one sulfur component. In some embodiments, the one or more solid-state electrolytes may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S— P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In).

In another embodiment, the solid-state electrolyte material may be one or more of a Li₃PS₄, Li₄P₂S₆, Li₇P₃S₁₁, Li₁₀GeP₂S₁₂, Li₁₀SnP₂S₁₂. In a further embodiment, the solid-state electrolyte may be one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y 2.0 and where the halogen may be one or more of F, Cl, Br, I, and the pseudo-halogen may be one or more of N, NH, NH₂, NO, NO₂, BF₄, BH₄, AlH₄, CN, and SCN. In yet another embodiment, the solid-state electrolyte material be expressed by the formula Li_{6-y}P₂S_{9-x-y}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

In some aspects, the solid-state electrolyte material may be present in the composite anode in an amount from about 0% to about 60% by weight of the composite anode; for example, the solid-state electrolyte may be present in the composite anode in an amount from about 0% to about 10% by weight, about 0% to about 20% by weight, about 0% to about 30% by weight, about 0% to about 40% by weight, about 0% to about 50% by weight, about 10% to about 60% by weight, about 20% to about 60% by weight, about 30% to about 60% by weight, about 40% to about 60% by weight, or about 50% to about 60% by weight. In some aspects, the solid-state electrolyte material may be present in the composite anode in an amount from about 5%, 10%, 15%, 20%, 25%, 30%, 35%, 40%, 45%, 50%, 55%, or 60% by weight of the composite anode. In an exemplary embodiment, the solid-state electrolyte material is present in an amount from about 35% to about 45% by weight of the composite anode.

The composite anode may further comprise a binder. The binder aids in adhesion of the composite anode to the current collector and provides the composite anode with the necessary structural integrity to withstand the formation of cracks while keeping the components of the composite close enough to ensure electron/ion mobility. The binder may also form a flexible matrix when mixed with the solid-state electrolyte material. The binder may further allow the silicon active material and the conductive additive to be suspended in the electrolyte matrix, allowing the electrode layer to maintain particle-to-particle contact while the silicon material expands and contracts. In some embodiments, the binder may comprise fluororesin containing vinylidene fluoride (VdF), hexafluoropropylene (HFP), tetrafluoroethylene (TFE), and derivatives thereof as structural units. In some additional embodiments, the binder may comprise homopolymers such as polyvinylidene fluoride (PVdF), polyhexafluoropropylene (PHFP), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR), ethylene propylene diene monomer rubber (EPDM) and the like.

In a further embodiment, the binder may comprise one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may comprise one or more of a nitrile rubber such as but not limited to acrylonitrile-butadiene rubber (ABR), polystyrene nitrile-butadiene rubber (PS-NBR), and mixtures thereof.

In preferred embodiments, the binder may comprise a styrenic block copolymer. In an exemplary embodiment, the binder may comprise SEBS. In another exemplary embodiment, the binder comprises SEBS and SBS.

In some aspects, the binder may be present in the composite anode in an amount from about 0% to about 20% by weight of the composite anode; for example, the binder may be present in the composite anode in an amount from about 0% to about 5%, about 0% to about 10%, about 0% to about 15%, about 5% to about 20%, about 10% to about 20%, or about 15% to about 20%. In an exemplary embodiment, the binder is present in the composite anode in an amount from about 4% to about 5% by weight. In another exemplary embodiment, the binder is present in the composite anode in an amount of about 2% by weight.

Further provided herein is a solid-state electrochemical cell comprising an composite anode of the present disclosure, a cathode layer, and a solid-state electrolyte layer (i.e., a separator layer). The solid-state electrolyte layer is disposed between the composite anode and the cathode layer. In some embodiments, the solid-state electrochemical cell further comprises a first current collector layer and a second current collector layer, wherein the first current collector layer is disposed adjacent to the composite anode and the second current collector layer is disposed adjacent to the cathode layer.

Preferably, the composite anodes of the electrochemical cell comprise less than 10 wt % Li₁₅Si₄ after lithiation. For example, the composite anodes of the present disclosure may comprise less than 10 wt % Li₁₅Si₄, less than 9 wt % Li₁₅Si₄, less than 8 wt % Li₁₅Si₄, less than 7 wt %, Li₁₅Si₄, less than 6 wt % Li₁₅Si₄, less than 5 wt % Li₁₅Si₄, less than 4 wt % Li₁₅Si₄, less than 3 wt % Li₁₅Si₄, less than 2 wt % Li₁₅Si₄, or less than 1 wt % Li₁₅Si₄ after lithiation.

The cathode layer may comprise a cathode active material such as (“NMC”) nickel-manganese-cobalt which can be expressed as Li(NiₐCo_{b}Mn_{c})O₂ (0<a<1, 0<b<1, 0<c<1, a+b+c=1) or, for example, NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}N_{0.2}Co_{0.2}O₂), NMC 811 (LiNi_{0.8}Mn_{0.1}Co_{0.1}O₂) or a combination thereof. In another embodiment, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-y}Co_{y}O₂, LiCo_{1-y}Mn_{y}O₂, LiNi_{1-y}Mn_{y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, Li(NiₐCo_{b}Al_{c})O₂ (0<a<1, 0<b<1, 0<c<1, a+b+c=1) or a combination thereof. In yet another embodiment, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), and nickel sulfide (Ni₃S₂) or combinations thereof. In another embodiment, the cathode active material may comprise one or more of a metal fluoride, such as but not limited to iron fluoride (FeF₂, FeF₃), copper fluoride (CuF₂), zinc fluoride (ZnF₂), titanium fluoride (TiF₄), and nickel fluoride (NiF₂).

The cathode layer may comprise one or more conductive additives. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, VGCF, silicon-carbon composites, and carbon nanotubes. In some aspects, the conductive additive may be present in the cathode layer in an amount from about 1% to about 10%.

The cathode layer may comprise one or more solid-state electrolytes. The one or more solid-state electrolyte may comprise an oxide, oxysulfide, sulfide, halide, nitride, or any other solid-state electrolyte known in the art. In some preferred embodiments, the one or more solid-state electrolytes may comprise a sulfide solid-state electrolyte. In some embodiments, the solid-state electrolyte comprises one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S— P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In another embodiment, the solid-state electrolyte may be one or more of a Li₃PS₄, Li₄P₂S₆, Li₇P₃S₁₁, Li₁₀GeP₂S₁₂, Li₁₀SnP₂S₁₂. In a further embodiment, the solid-state electrolyte may be one or more of a Li₆PS₅Cl, Li₆PS₅Br, Li₆PS₅I or expressed by the formula Li_{7-y}PS_{6-y}X_{y} where “X” represents at least one halogen and/or at least one pseudo-halogen, where 0<y 2.0, and where the at least one halogen may be one or more of F, Cl, Br, I, and the at least one pseudo-halogen may be one or more of N, NH, NH₂, NO, NO₂, BF₄, BH₄, AlH₄, CN, and SCN. In yet another embodiment, the solid-state electrolyte be expressed by the formula Li_{6-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, Cl, Br, I, and a pseudo-halogen may be one or N, NH, NH₂, NO, NO₂, BF₄, BH₄, AlH₄, CN, and SCN. In some aspects, the solid state electrolyte may be present in the cathode layer in an amount from about 5% to about 20%.

The cathode layer may comprise one or more of a binder. In some embodiments, the binder may include fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof. In some aspects, the binder may be present in the cathode layer in an amount from about 0% to about 5%.

The electrolyte layer (also referred to herein as the “separator layer”) may comprise one or more solid-state electrolytes. The one or more solid-state electrolytes may comprise an oxide, oxysulfide, sulfide, halide, nitride, or any other solid-state electrolyte known in the art. In some preferred embodiments, the one or more solid-state electrolytes may comprise a sulfide solid-state electrolyte. In some aspects, the one or more sulfide solid-state electrolyte may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S— P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In). In some embodiments, one or more of the solid electrolyte materials may be Li₃PS₄, Li₄P₂S₆, Li₇P₃S₁₁, Li₁₀GeP₂S₁₂, Li₁₀SnP₂S₁₂, and combinations thereof. In another embodiment, one or more of the solid electrolyte materials may be Li₆PS₅Cl, Li₆PS₅Br, Li₆PS₅I or expressed by the formula Li_{7-y}PS_{6-y}X_{y}, where “X” represents at least one halogen and/or at least one pseudo-halogen, where 0<y≤2.0, and where the halogen may be one or more of F, Cl, Br, I, and combinations thereof, and the pseudo-halogen may be one or more of N, NH, NH₂, NO, NO₂, BF₄, BH₄, AlH₄, CN, SCN, and combinations thereof. In another embodiment, one or more of the solid electrolyte materials may be expressed by the formula Li_{6-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, SCN, and combinations thereof.

The electrolyte layer may further comprise one or more of a binder. In some embodiments, the binder may include fluororesin containing vinylidene fluoride (VdF), hexafluoropropylene (HFP), tetrafluoroethylene (TFE), and derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may be one or more of an acrylic resin such as but not limited to polymethyl(meth)acrylate, polyethyl(meth)acrylate, polyisopropyl(meth)acrylate polyisobutyl(meth)acrylate, polybutyl(meth)acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof. In some aspects, the binder may be present in the electrolyte layer in an amount from about 0% to about 20% by weight.

In some embodiments, the electrolyte layer may have a thickness from about 10 μm to about 40 μm. In some aspects, the electrolyte layer may have a thickness from about 10 μm to about 20 μm, about 10 μm to about 30 μm, about 20 μm to about 30 μm, about 20 μm to about 40 μm, or about 30 μm to about 40 μm. In some additional aspects, the electrolyte layer may have a thickness of about 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, or about 40 μm.

The first current collector and the second current collector may comprise one or more of copper, aluminum, nickel, titanium, stainless steel, magnesium, iron, zinc, indium, germanium, silver, platinum, or gold. The current collector may further comprise a carbon coating adjacent to the composite anode or the cathode layer. In some embodiments, the first current collector or the second current collector may have a thickness from about 5 μm to about 10 μm. In preferred embodiments, the first current collector comprises copper, nickel, and/or steel.

In general, when a higher stack pressure is applied during the first cell cycle, the electrochemical cell may have a greater capacity retention as compared to an electrochemical cell having less stack pressure applied during the first cell cycle.

Although the specific capacity of the cathode layer of the electrochemical cells decreases after every charge/discharge cycle, the decrease in the specific capacity of the cathode layer of the electrochemical cells of the present disclosure is reduced compared to electrochemical cells using micro-scale silicon. In some embodiments, the cathode layer of the electrochemical cell of the present disclosure may have a specific capacity of greater than 100 mAh/g for at least 100 cycles. For example, the cathode layer of the electrochemical cell may have a specific capacity of greater than 100 mAh/g for 100 cycles, 150 cycles, 200 cycles, 250 cycles, 300 cycles, 400 cycles, 500 cycles, 600 cycles, 700 cycles, 800 cycles, or more than 800 cycles.

In some embodiments, the electrochemical cells of the present disclosure have an increased retention capacity compared to cells having an composite anode comprising micro-scale silicon. In some embodiments, the electrochemical cell may have a capacity retention of about 80% or greater after 100 cycles or more; for example, the electrochemical cell may have a capacity retention of about 80% or greater after about 100 cycles, 200 cycles, 300 cycles, 400 cycles, 500 cycles, 600 cycles, 700 cycles, 800 cycles, 900 cycles, 1000 cycles, or more than about 1000 cycles.

In some embodiments, the electrochemical cells of the present disclosure comprise: a current collector; and, an composite anode, the composite anode comprising silicon or an alloy thereof, at least one solid electrolyte material, and at least one binder material; and, further wherein within the electrochemical cell there is no physical separation or lift-off between the current collector and composite anode after 5 cycles or more; for example, 10 cycles, 25 cycles, 50 cycles, 75 cycles, 100 cycles, 200 cycles, 300 cycles, 400 cycles, 500 cycles, 600 cycles, 700 cycles, 800 cycles, 900 cycles, 1000 cycles, or more than about 1000 cycles.

Also provided herein is a method of preparing a composite anode for use in a solid-state electrochemical cell. The method may comprise: a) combining silicon or an alloy thereof, at least one solid electrolyte material, and at least one binder material; b) mixing the silicon or alloy thereof, the at least one solid electrolyte material and at least one binder material to form a composite mixture; c) adding a solvent to the composite mixture to form a slurry; d) casting the slurry onto a substrate; and e) drying the slurry to form the composite anode.

In some embodiments, the solvent may be selected from but is not limited to one or more of the following: aprotic hydrocarbons, esters, ethers, nitriles, or combinations thereof. In another aspect, the aprotic hydrocarbons may be selected from but are not limited to one of the following: xylenes, toluene, benzene, methyl benzene, hexanes, heptane, octane, alkanes, isoparaffinic hydrocarbons or a combination thereof. In another aspect, the esters may be selected from but are not limited to one of the following: butyl butyrate, isobutyl isobutyrate methyl propionate, ethyl propionate, propyl propionate, butyl propionate, methyl acetate, ethyl acetate, propyl acetate, butyl acetate or a combination thereof. In another aspect, the ethers may be selected from but are not limited to one of the following: diethyl ether, dibutyl ether, benzyl ether or a combination thereof. In another aspect, the nitriles may be selected from but are not limited to one of the following: acetonitrile, propionitrile, butyronitrile, pyrrolidine or a combination thereof.

After the composite anode is dried on the substrate, the anode is densified to increase the density of the composite anode. Methods of densification are well-known to those having skill in the art. In preferred embodiments, the densification is accomplished by calendering or by pressing, e.g., with a linear press. In some embodiments, the temperature during densification may be about 80° C. to about 140° C. It will be appreciated that the density of the composite anode will depend on the formulation of the composite anode as well as the densification conditions. Without wishing to be bound by theory, increasing the density of the composite anode reduces the porosity of the composite anode, thereby improving contacts between particles and lowering the resistance of the composite anode.

In some embodiments, the density of the composite anode after densification may be from about 1 g/cm³ to about 1.75 g/cm³; for example, the density of the composite anode after densification may be about 1 g/cm³, 1.05 g/cm³, 1.1 g/cm³, 1.15 g/cm³, 1.2 g/cm³, 1.25 g/cm³, 1.3 g/cm³, 1.35 g/cm³, 1.4 g/cm³, 1.45 g/cm³, 1.5 g/cm³, 1.55 g/cm³, 1.6 g/cm³, 1.65 g/cm³, 1.7 g/cm³, or about 1.75 g/cm³. In another example, the density of the composite anode after densification may be from about 1 g/cm³ to about 1.1 g/cm³, about 1 g/cm³ to about 1.2 g/cm³, about 1 g/cm³ to about 1.3 g/cm³, about 1 g/cm³ to about 1.4 g/cm³, about 1 g/cm³ to about 1.5 g/cm³, about 1 g/cm³ to about 1.6 g/cm³, about 1 g/cm³ to about 1.7 g/cm³, about 1.1 g/cm³ to about 1.75 g/cm³, about 1.2 g/cm³ to about 1.75 g/cm³, about 1.3 g/cm³ to about 1.75 g/cm³, about 1.4 g/cm³ to about 1.75 g/cm³, about 1.5 g/cm³ to about 1.75 g/cm³, about 1.6 g/cm³ to about 1.75 g/cm³, or about 1.7 g/cm³ to about 1.75 g/cm³.

The composite anode may have a porosity from about 25% to about 50%. In some embodiments, the composite anode may have a porosity from about 25% to about 30%, about 25% to about 35%, about 25% to about 40%, about 25% to about 45%, about 25% to about 50%, about 30% to about 50%, about 35% to about 50%, about 40% to about 50%, or about 45% to about 50%.

Further provided herein is an anode composition comprising an anode active material, a solid-state electrolyte material, a conductive additive, and a binder, wherein the composition has a density from about 1 g/cm³ to about 1.75 g/cm³. The anode active material, solid-state electrolyte material, conductive additive, and the binder may be selected from any of the materials identified earlier in the present disclosure and in any amounts defined earlier in the present disclosure. In some embodiments, the composition may be subjected to a stack pressure from about 100 psi to about 2500 psi, or greater than 2500 psi.

In an exemplary embodiment, an composite anode of the present disclosure comprises silicon in an amount of about 85% by weight of the composite anode, a conductive additive in an amount of about 10% by weight of the composite anode, and a binder in an amount of about 5% by weight of the composite anode.

In another exemplary embodiment, the composite anode of the present disclosure comprises silicon in an amount from about 48% to about 52% by weight of the composite anode, a binder in an amount from about 2% to about 6% by weight of the composite anode, and a solid-state electrolyte in an amount from about 44% to about 48% by weight of the composite anode. In a further configuration, an composite anode of the present disclosure comprises silicon in an amount of about 50% by weight of the composite anode, a binder in an amount of about 4% by weight of the composite anode, and a solid-state electrolyte in an amount of about 46% by weight of the composite anode.

Unless defined otherwise, all technical and scientific terms used herein have the same meaning as commonly understood by those of ordinary skill in the art to which the disclosure belongs. Although any methods and materials similar or equivalent to those described herein can be used in the practice or testing of the subject matter of the present disclosure, preferred methods and materials are described. For the purposes of the present disclosure, the following terms are defined below.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

The term “about” will be understood by persons of ordinary skill in the art and will vary to some extent on the context in which it is used. As used herein when referring to a measurable value such as an amount, a temporal duration, and the like, the term “about” is meant to encompass variations of ±10%, including ±5%, ±1%, and ±0.1% from the specified value, as such variations are appropriate to perform the disclosed methods.

In this disclosure, “comprises,” “comprising,” “containing,” and “having” and the like can have the meaning ascribed to them in U.S. Patent Law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. In this specification when using an open ended term, like “comprising” or “including,” it is understood that direct support should be afforded also to “consisting essentially of” language as well as “consisting of” language as if stated explicitly and vice versa.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Example 1: Physical Properties of Silicon

Silicon powders were used as received from manufacturers. Particle size information was provided by the supplier. Surface area was determined using 11-point Brunauer-Emmett-Teller (BET) analysis with nitrogen adsorption on a Quantachrome NOVAtouch Gas Sorption Analyzer.

Scherrer analysis: X-ray powder diffraction was performed on a Bruker D2 Phaser instrument. The results were gathered with a 30 kV generator and the wavelength of the incident x-rays from the Cu—K_{α} is ˜1.54 Å. Using the Scherrer equation:

$$D = \frac{κλ}{βcosθ}$$

where κ is a constant from 0.89-1, λ is the wavelength of the incident x-rays, β is the full width at half maximum measured in radians, and θ is the Bragg angle. The range of crystallite sizes for each material type was determined by analyzing the [111], [220], and [311] crystallographic planes corresponding to approximate 2θ values of 28.45, 47.30, 56.12 degrees, respectively. The physical properties are summarized in Table 1 below.

TABLE 1

| Example | Particle Size | | Crystallite Size | | Surface Area | |
|---|---|---|---|---|---|---|
| Example 1 | 50-80 | nm | 10-13 | nm | 10-20 | m²/g |
| Comparative Example 1 | 50 | nm | 8 | nm | 70-100 | m²/g |
| Comparative Example 2 | 200-300 | nm | 34-45 | nm | 6 | m²/g |

Production of the Electrolyte Material: Li₂S, P₂S₅, and LiCl were combined in a stoichiometric ratio of 5:1:2 to produce the desired sulfide solid electrolyte. This combination was added to a 500 ml zirconia milling jar with zirconia milling media and xylenes as a solvent. The mixture is milled in a Retsch PM 100 planetary mill for 12 hours at 400 RPM. The material was collected and dried at 70° C. in an inert argon environment. The resulting solid electrolyte powder was then further heated to 450° C. for 2 hours.

Production of Positive Electrode: NMC (Nickel-Manganese-Cobalt Oxide), Li₂S:P₂S₅:LiCl based solid electrolyte material, a carbon based conductive additive comprising a mixture of graphite and carbon black, and a binder comprising PVDF-HFP and SEBS were mixed at the desired ratio in isobutyl isobutyrate. The mixture was then dried and used as a positive electrode material.

Production of Negative Electrode: Three negative electrodes were produced, labelled “Example 1”, “Comparative Example 1”, and “Comparative Example 2.”

Example 1: Si material having a particle size of 50-80 nm, a surface area of 10-20 m²/g, and a crystallite size of 10-13 nm was mixed with a Li₂S:P₂S₅:LiCl based solid electrolyte material, a carbon based conductive additive comprising carbon black, and a binder comprising SEBS were mixed at the desired ratio in isobutyl isobutyrate. The mixture was then dried and used as the negative electrode material of Example 1.

Comparative Example 1: Si material having a particle size of 50 nm, a surface area of 70-100 m²/g, and a crystallite size of 8 nm was mixed with a Li₂S:P₂S₅:LiCl based solid electrolyte material, a carbon based conductive additive comprising carbon black, and a binder comprising SEBS were mixed at the desired ratio in isobutyl isobutyrate. The mixture was then dried and used as the negative electrode material of Comparative Example 1.

Comparative Example 2: Si material having a particle size of 200-300 nm, a surface area of 6 m²/g, and a crystallite size of 34-45 nm was mixed with a Li₂S:P₂S₅:LiCl based solid electrolyte material, a carbon based conductive additive, and one or more binders were mixed at the desired ratio in one or more solvents. The mixture was then dried and used as the negative electrode material of Comparative Example 2.

In each of the above examples, the silicon was mixed with the solid electrolyte material, a carbon based conductive additive comprising carbon black, and a binder comprising SEBS. Isobutyl isobutyrate was added to the composite mixture to form a slurry with rheological properties (i.e., viscosity and power law behavior) ideal for casting/coating. The slurry was then coated onto a substrate and dried to form the composite anode.

The composite anodes were incorporated into electrochemical cells having lithium metal as the counter electrode. The cells were cycled between 0.05 V and 1.0 V. The first cycle efficiency was calculated by determining the ratio of the first cycle delithiation capacity of the silicon electrode to the first cycle lithiation capacity of the silicon electrode.

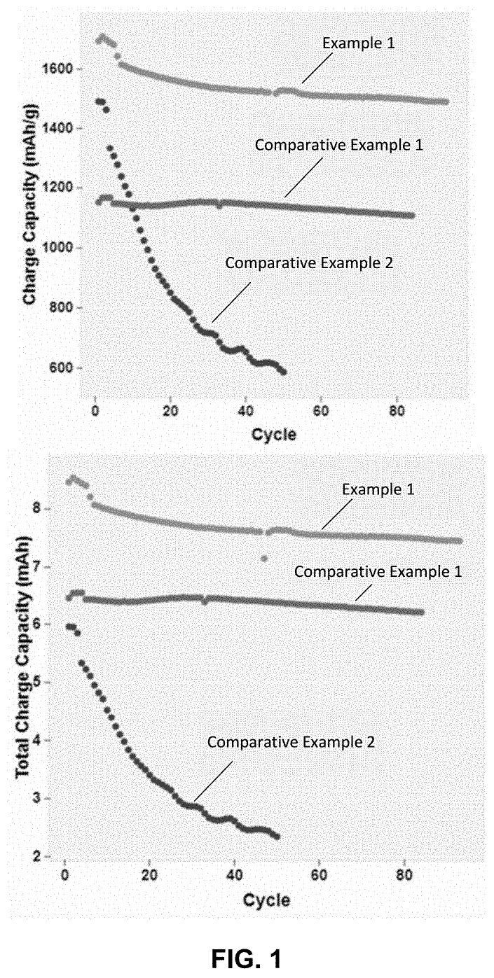

As can be seen in FIG. 1, Comparative Example 1 had a small particle size and good cycling stability. However, the high surface area and greater surface oxide made it challenging to cast and reduced the first cycle efficiency (84.5%) and capacity. Comparative Example 2 has low surface area which improved the first cycle efficiency (91.2%) and capacity. The silicon of Example 1 combined small particle size and low surface area for a surprisingly high first cycle efficiency (94.5%), high capacity, and good cycle life.

Therefore, it was observed that particles with small crystallite size but high surface area or large crystallite size but low surface area are unable to cycle with high capacity and long cycle life. It is the unique architecture of small crystallite size with low surface area combined with a solid state electrolyte that enable near theoretical capacity and long cycle life. Without wishing to be bound by theory, it is believed that this effect is achieved because the Si nanoparticles are connected and therefore reduce the specific area of the material by blocking access of electrolyte to Si at these connection sites while maintaining a surface area less than less than 20 m²/g.

### Example 2: Physical Properties of Silicon

Additional composite anodes and comparative composite anodes were prepared. The properties of these compositions are shown in Table 2. Si material having a particle size of 100-180 nm, a surface area of 20-30 m²/g, and a crystallite size of 17-20 nm was mixed with a Li₂S:P₂S₅:LiCl based solid electrolyte material, a carbon based conductive additive comprising carbon black, and binder comprising SEBS were mixed at the desired ratio in isobutyl isobutyrate. The mixture was then dried and used as the negative electrode material of Example 2.

Comparative Example 3: Si material having a particle size of 200-400 nm, a surface area of 30-40 m²/g, and a crystallite size of 30-40 nm was mixed with a Li₂S:P₂S₅:LiCl based solid electrolyte material, a carbon based conductive additive comprising carbon black, and a binder comprising SEBS were mixed at the desired ratio in isobutyl isobutyrate. The mixture was then dried and used as the negative electrode material of Comparative Example 3.

Comparative Example 4: Si material having a particle size of 1000-8000 nm, a surface area of 4-6 m²/g, and a crystallite size of 31-42 nm was mixed with a Li₂S:P₂S₅:LiCl based solid electrolyte material, a carbon based conductive additive comprising carbon black, and a binder comprising SEBS were mixed at the desired ratio in isobutyl isobutyrate. The mixture was then dried and used as the negative electrode material of Comparative Example 4.

TABLE 2

| | | Crystallite | |
|---|---|---|---|
| Example | Particle Size | Size | Surface Area |
| Example 2 | 100-180 nm | 10-13 nm | 10-20 m²/g |
| Comparative Example 3 | 200-400 nm | 30-40 nm | 30-40 m²/g |
| Comparative Example 4 | 1000-8000 nm | 31-42 nm | 4-6 m²/g |

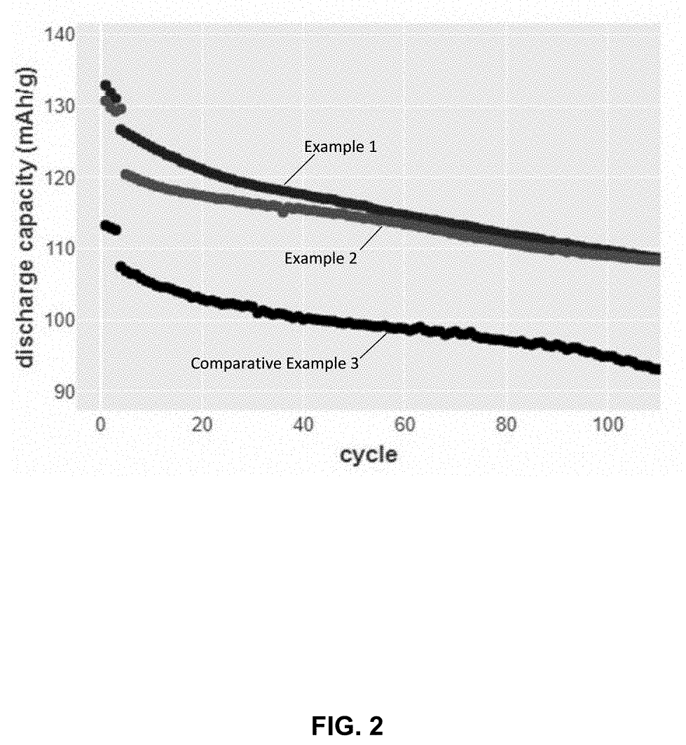

The composite anodes were incorporated into pouch cells, which were then cycled at a stack pressure of about 300 psi, a voltage window of 2.5V-4.1 V, and a temperature of about 45° C. The silicon content of each anode composition was about 50% by weight. As can be seen in FIG. 2, Example 2 had a particle size, crystallite size, and surface area within the desired ranges and shows similar cycle life performance as Example 1. While Comparative Example 3 had a crystallite size within the desired range, the particle size was higher than that of the materials used in Example 1 and Example 2. Furthermore, the surface area of the material used in Comparative Example 3 is outside of the desired range and thus a lower overall discharge capacity was achieved. The silicon of Example 2 combined small particle size, low surface area, and low crystallite size for superior cycle life.

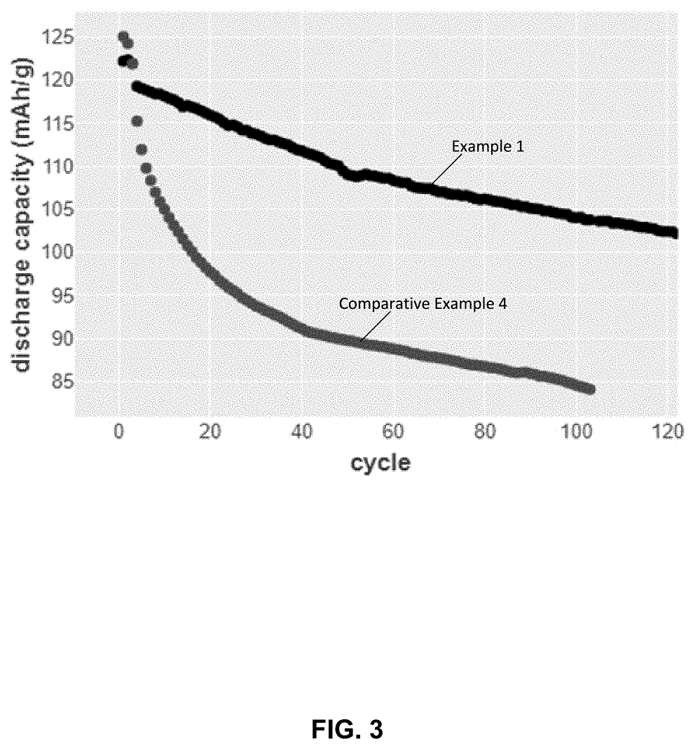

In another experiment, the composite anodes were incorporated into die cells and were cycled at a stack pressure of about 1000 psi, a voltage window of 2.5 V-4.25 V, and a temperature of 70° C. The silicon content of the composite anodes was about 52% by weight. As can be seen in FIG. 3, Comparative Example 4 had a surface area in the desired range but had a crystallite size and particle size over the desired range. This resulted in poor cycle life and rapid drop in discharge capacity.

Features described above as well as those claimed below may be combined in various ways without departing from the scope hereof. It should thus be noted that the matter contained in the above description or shown in the accompanying drawings should be interpreted as illustrative and not in a limiting sense. The above-described embodiments should be considered as examples of the present invention, rather than as limiting the scope of the invention. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover generic and specific features described herein, as well as all statements of the scope of the present method and system, which, as a matter of language, might be said to fall there between.

What is claimed is:

1. A composite anode for an electrochemical cell comprising:
silicon or an alloy thereof in an amount of at least about 30 wt % of the composite anode;
a solid electrolyte material in an amount from about 0 wt % to about 40 wt % of the composite anode; and
a binder in an amount from about 0 wt % to about 20 wt % of the composite anode.

2. The composite anode of claim 1, wherein the silicon has a particle size from about 10 nm to about 300 nm.

3. The composite anode of claim 1, wherein the silicon has a particle size from about 50 nm to about 80 nm.

4. The composite anode of claim 1, further comprising a conductive additive in an amount of about 0 wt % to about 15 wt % of the composite anode.

5. The composite anode of claim 4, wherein the conductive additive comprises carbon.

6. The composite anode of claim 4, wherein the conductive additive has a particle size from about 5 nm to about 100 nm.

7. The composite anode of claim 1, wherein the silicon has a crystallite size from about 1 nm to about 50 nm.

8. The composite anode of claim 1, wherein the silicon has a crystallite size from about 1 nm to about 20 nm.

9. The composite anode of claim 1, wherein the silicon has a surface area of less than about 20 m²/g.

10. The composite anode of claim 1, wherein the silicon has a surface area from about 1 m²/g to about 50 m²/g.

11. The composite anode of claim 1, wherein the silicon has a surface area from about 1 m²/g to about 20 m²/g.

12. The composite anode of claim 1, wherein the composite anode has a density from about 1 g/cm³ to about 1.75 g/cm³.

13. The composite anode of claim 1, further comprising an anode active material including tin, germanium, graphite, Li₄Ti₅O₁₂, hard carbons, or combinations thereof.

14. The composite anode of claim 1, wherein the silicon is present in an amount from about 30 wt % to about 98 wt % of the composite anode.

15. The composite anode of claim 1, wherein the silicon is present in an amount of at least about 40 wt % of the composite anode.

16. The composite anode of claim 1, wherein the silicon has a ratio of crystallite size to surface area (nm:m²/g) from about 1:50 to about 50:1.

17. The composite anode of claim 1, wherein the silicon has a ratio of crystallite size to particle size (nm:nm) from about 1:300 to about 1:1.

18. The composite anode of claim 1, wherein the silicon has a ratio of surface area to particle size (m²/g:nm) from about 1:300 to about 50:10.

19. A composite anode for an electrochemical cell comprising:
silicon or an alloy thereof in an amount of at least about 30 wt % of the composite anode;
a solid electrolyte material in an amount from about 0 wt % to about 40 wt % of the composite anode; and
a binder in an amount from about 0 wt % to about 20 wt % of the composite anode, wherein the silicon has two or more of the following properties:
a particle size from about 10 nm to about 100 nm;
a crystallite size from about 1 nm to about 20 nm; and
a surface area from about 1 m²/g to about 20 m²/g.

20. An electrochemical cell comprising:
a composite anode including:
silicon or an alloy thereof in an amount of at least about 30 wt % of the composite anode;
a solid electrolyte material in an amount from about 0 wt % to about 40 wt % of the composite anode; and
a binder in an amount from about 0 wt % to about 20 wt % of the composite anode a cathode; and
an electrolyte layer.

21. The electrochemical cell of claim 20, wherein the silicon has a particle size from about 10 nm to about 100 nm.

22. The electrochemical cell of claim 20, wherein the silicon has a particle size from about 50 nm to about 80 nm.

23. The electrochemical cell of claim 20, wherein the composite anode further includes a conductive additive in an amount of about 0 wt % to about 15 wt % of the composite anode.

24. The electrochemical cell of claim 23, wherein the conductive additive comprises carbon.

25. The electrochemical cell of claim 20, wherein the silicon has a crystallite size from about 1 nm to about 50 nm.

26. The electrochemical cell of claim 20, wherein the silicon has a crystallite size from about 1 nm to about 20 nm.

27. The electrochemical cell of claim 20, wherein the silicon has a surface area of less than about 20 m²/g.

28. The electrochemical cell of claim 20, wherein the silicon has a surface area from about 1 m²/g to about 50 m²/g.

29. The electrochemical cell of claim 20, wherein the silicon has a surface area from about 1 m²/g to about 20 m²/g.

30. The electrochemical cell of claim 20, wherein the composite anode has a density from about 1 g/cm³ to about 1.75 g/cm³.
